(19) United States
(12) Patent Application Publication
(10) Pub. No.: US 2025/0179841 A1
(43) Pub. Date: Jun. 5, 2025

(54) MOTOR VEHICLE LOCK, IN PARTICULAR MOTOR VEHICLE DOOR LOCK

(71) Applicant: KIEKERT AG, Heiligenhaus (DE)

(72) Inventor: Jan ZEJDA, Chrudim (CZ)

(73) Assignee: KIEKERT AG, Heiligenhaus (DE)

(21) Appl. No.: 18/845,190

(22) PCT Filed: Feb. 24, 2023
(86) PCT No.: PCT/DE2023/100148

§ 371 Date: Sep. 9, 2024

(30) Foreign Application Priority Data
Mar. 31, 2022 (DE) 10 2022 107 656.3

(51) Int. Cl. E05B 81/14; E05B 81/06; E05B 81/30; E05B 81/34; E05B 81/68

(52) U.S. Cl. CPC E05B 81/14; E05B 81/06; E05B 81/30; E05B 81/34; E05B 81/68

(57) ABSTRACT

A motor vehicle lock, in particular a motor vehicle door lock, which, in its basic design, is equipped with a locking mechanism consisting essentially of a rotary latch and a pawl. Furthermore, a closing drive and an opening drive for the locking mechanism are implemented. In addition, a drive pawl for acting on the locking mechanism is implemented. According to the invention, a single and combined opening/closing drive is implemented, which acts on the drive pawl optionally in an opening direction for acting on the pawl and in an opposite closing direction for acting on the rotary latch.

The invention relates to a motor vehicle lock, in particular a motor vehicle door lock comprising a locking mechanism consisting essentially of a rotary latch and a pawl, further comprising a closing drive and an opening drive for the locking mechanism, and comprising a drive pawl for acting on the rotary latch.

As a rule, the locking mechanism, which essentially consists of a rotary latch and a pawl, is designed as a single-pawl locking mechanism, i.e., it has one (single) pawl. In principle, however, the invention also includes so-called multi-pawl locking mechanisms with two pawls.

In the generic prior art according to DE 10 2018 113 270 A1, a closing drive and an opening drive are provided for the locking mechanism. The rotary latch can be moved into an overstroke position by means of the closing drive. To open the locking mechanism, the rotary latch is held in the overstroke position by means of the closing drive. This allows the opening drive to open the pawl and the closing drive then returns to its basic position when the locking mechanism is open. In this way, the overall noise generated during the opening process of the locking mechanism should be reduced compared to previous designs.

The further prior art according to DE 10 2019 135 464 A1 relates to a motor vehicle lock which is equipped with a closing drive and an opening device. The closing drive has at least one pivot lever which can be acted upon by an electric motor and a closing pawl which works on the rotary latch. The opening device is equipped with a toggle lever arrangement which couples the pivot lever and the closing pawl in the closing operation and separates them for opening.

The known motor vehicle locks have generally proven themselves and work reliably because ultimately, the opening drive and the closing drive for the locking mechanism are spatially and functionally separate from one another. The further prior art according to DE 20 2008 015 789 U1 also relates to embodiments that make use of a closing/opening device. At this point, however, the design is such that the drive either ensures a closing movement of the locking mechanism or an opening movement. That has also proven successful.

If one looks at the first two embodiments according to the generic DE 10 2018 1 13 270 A1 on the one hand and DE 10 2019 135 464 A1 on the other, it becomes clear that the spatial and functional separation of the opening drive and the closing drive results in a relatively complex structure, which can also be understood overall. Otherwise, mutual functional impairments are possible. However, in the interests of cost-effective production, it is desirable to combine individual functionalities. There are currently no convincing solutions for this in the prior art.

Accordingly, the invention is based on the technical problem of further developing such a motor vehicle lock and in particular a motor vehicle door lock in such a way that simplifications are observed in terms of design and production compared to the prior art.

To solve this technical problem, a generic motor vehicle lock and in particular a motor vehicle door lock is characterized within the scope of the invention in that a single and combined opening/closing drive is implemented, which works on the drive pawl optionally in an opening direction for acting on the pawl and in an opposite closing direction for acting on the rotary latch.

In contrast to the generic prior art according to DE 10 2018 113 270 A1 or the teaching according to DE 10 2019 135 464 A1, the invention therefore no longer relies on a closing drive and, separately, an opening drive for the locking mechanism, i.e., on two electromotive drives. Rather, according to the invention, a single electromotive drive is used, namely the single and combined opening/closing drive. With the aid of this combined opening/closing drive, the desired locking mechanism opening as well as a closing process are realized and implemented.

For this purpose, the single and combined opening/closing drive works according to the invention on the drive pawl, which optionally acts on the pawl in its opening direction and on the rotary latch in the opposite closing direction. Although such a drive is generally described in DE 20 2008 015 789 U1, it is only described in such a way that either a closing process or an opening process can be realized and implemented in the sense of an “either/or” relationship.

In contrast, the invention works with the single and combined opening/closing drive, which is acted upon on the one hand in the opening direction and on the other in the opposite closing direction. In the opening direction, the opening/closing drive in conjunction with the drive pawl ensures that the pawl is lifted from its locking engagement with the rotary latch. As a result, the rotary latch can then open in a spring-assisted manner and release a previously held locking bolt. An electromotive opening drive is connected thereto.

At the same time, according to the invention, the single and combined opening/closing drive is capable of closing the rotary latch via the drive pawl in the closing direction opposite to the opening direction. In this case, the drive pawl ensures that the rotary latch—for example starting from a pre-locking position—is moved further in the direction of the main locking position by means of the drive pawl. For this purpose, the single and combined opening/closing drive is moved in the closing direction.

In this way, a motor vehicle lock is provided within the scope of the invention which dispenses with two separate electromotive drives, on the one hand for the electromotive opening process and on the other hand for the electromotive closing process, but rather maps both functionalities by means of the single and combined opening/closing drive including drive pawl. This saves both manufacture and assembly costs. In addition, the weight is reduced. Furthermore, the embodiment according to the invention is characterized by a particularly compact design, thus requiring significantly less installation space compared to the prior art. These are the main advantages.

According to a further advantageous embodiment, the drive pawl is equipped with a toothing for engagement with a gear wheel of the combined opening/closing drive. The drive pawl is usually a toothed segmented wheel which is designed to rotate about its axis. The toothed segmented wheel is characterized in that the toothing is only implemented on one peripheral segment, the toothed segment, into which the gear wheel of the opening/closing drive engages to drive the drive pawl.

In order to be able to act on the pawl or the rotary latch, the drive pawl has an extension arm that can work either on the pawl or the rotary latch. In most cases, the procedure is still such that a toothed segment of the drive pawl and the extension arm are arranged at an angular distance from one another.

The angular distance between the toothed segment and the drive pawl prevents any functional impairments when the drive pawl is acted upon by means of the combined opening/closing drive. This is also helped by the fact that the drive pawl is usually pot-shaped in cross section with a central axis of rotation and a peripheral toothed segment and an extension arm.

The pot-shaped design of the drive pawl in cross section takes into account the fact that the drive pawl is usually additionally equipped with a contour for interaction with a sensor which queries the angular position of the drive pawl. The contour is typically found on a truncated cylinder, which can be connected to the drive pawl (in a rotationally fixed manner) or is designed as a single piece therewith. The truncated cylinder not only defines the central axis of rotation of the drive pawl, but is also equipped with the required contour on its outer circumference, which can be queried using the sensor in order to determine the angular position of the drive pawl. As a result of the pot-shaped nature of the drive pawl in cross section, the drive pawl can overlap the truncated cylinder in question, so that both the peripheral toothed segment and the extension arm are displaced into an associated plane spanned by the locking mechanism.

In addition, and advantageously, the extension arm of the drive pawl is arranged in the unloaded state in a parking region which does not act on the pawl or the rotary latch. The parking region can be detected using the sensor.

In this way, additional stops, rubber buffers, etc. for the drive pawl are expressly unnecessary. Rather, the interaction between the contour on the truncated cylinder on the one hand and the sensor which queries the contour on the other ensures that the drive pawl, in its unloaded state, occupies the parking region in question. This is deliberately a position range of the drive pawl in the unloaded state, which takes any external influences into account.

The basic position assumed by the drive pawl in the unloaded state by the combined opening/closing drive depends on factors such as the voltage acting on the opening/closing drive, the temperature, or the direction in which the drive pawl is loaded, i.e., whether it assumes its basic position coming from the opening direction or coming from the closing direction. Either way, the parking region is expressly and in accordance with the invention permitted and detected using the sensor. This corresponds to a position range and consequently an angle range of the drive pawl, which it can assume in its basic position. This eliminates the need for additional stops, stoppers, etc., which also helps to reduce weight, manufacturing costs and price.

This is also helped by the fact that the drive pawl is advantageously designed as a metal molded part or a plastics molded part. The same applies to the truncated cylinder. The drive pawl on the one hand and the truncated cylinder on the other can be designed in two parts. As a rule, however, it is a one-piece plastics molded part or metal molded part. Both the metal molded part and the plastics molded part can be designed as injection molded parts.

As a result, a motor vehicle lock and in particular a motor vehicle door lock is provided which, in a structurally strikingly simple manner, is able to provide both an electromotive opening and closing process of the locking mechanism. This can be attributed to the fact that a single combined opening/closing drive is responsible for both processes. In conjunction with the specially designed drive pawl, the different directions of rotation of the combined opening/closing drive are used to actuate the drive pawl in the opening device on the one hand and in the opposite closing device on the other. These are the main advantages.

In the following, the invention is explained in more detail with the aid of a drawing showing only one embodiment; in the figures:

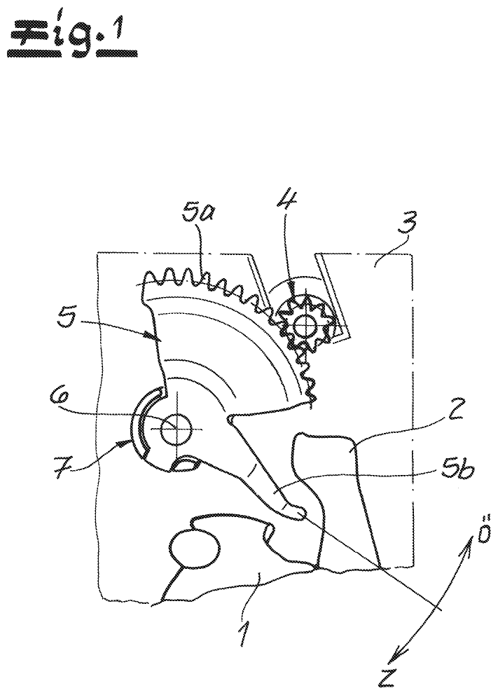

FIGS. 1 to 3 show the motor vehicle lock according to the invention in different views.

The figures show a motor vehicle lock and in particular a motor vehicle door lock. In its basic structure, said lock has a locking mechanism 1, 2 consisting essentially of a rotary latch 1 and a pawl 2. This can be seen primarily from FIG. 1. For this purpose, the locking mechanism 1, 2 is mounted in a lock housing 3, which is or may be made largely of plastics. In addition, the basic structure includes a closing drive 4 and an opening drive 4 for the aforementioned locking mechanism 1, 2, whereby according to the embodiment and according to the invention a single and combined opening/closing drive 4 is implemented.

In addition, a drive pawl 5 is provided, with the aid of which the rotary latch 1 or the locking mechanism 1, 2 can be acted upon. By means of the single and combined opening/closing drive 4 provided according to the invention, the drive pawl 5 can be controlled optionally in an opening direction Ö for acting on the pawl 2 and in an opposite closing direction Z for acting on the rotary latch 1. This can best be seen in FIG. 1, where both the opening direction Ö and the closing direction Z are shown.

According to the embodiment, the opening direction Ö corresponds to a pivoting movement of the drive pawl 5 about its axis 6 in the counterclockwise direction, whereas the closing direction Z of the drive pawl 5 corresponds to a rotation of the drive pawl 5 about its axis 6 in the clockwise direction.

It can be seen that the drive pawl 5 is equipped with a toothing 5a. According to the embodiment, the toothing 5a serves to engage a gear wheel 4 of the combined and single opening/closing drive 4. According to the embodiment, the gear wheel 4 and the opening/closing drive 4 coincide in terms of design. However, it must be taken into account that the opening/closing drive 4 may also have an electric motor and an intermediate gear in addition to the gear wheel 4, which is not shown in detail for the sake of improved and clearer illustration.

The drive pawl 5 is a toothed segment wheel which is rotatable about the axis 6. This can be attributed to the fact that the toothing 5a in connection with the circular drive pawl 5 is only implemented and provided on a peripheral segment of the drive pawl 5. Consequently, a toothed segment 5a is observed. The drive pawl 5 additionally has an extension arm 5b which can optionally act on the pawl 2 or the rotary latch 1.

It can be seen that the toothed segment 5a of the drive pawl 5 and the extension arm 5b are arranged at an angular distance from one another. An angular distance a in the range of approximately 90° is observed between the toothed segment 5a and the extension arm 5b according to the embodiment and with respect to the common axis of rotation 6, which of course is only an example and not restrictive. In any case, one edge of the toothed segment 5a and the extension arm 5b are spaced apart from one another. In this way, any mutual functional impairments are excluded.

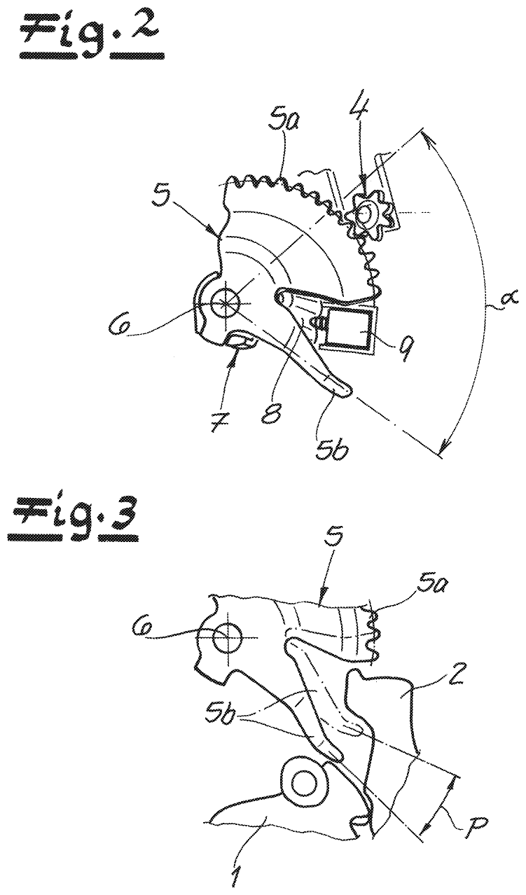

In particular, by comparing FIGS. 1 and 2, it can be seen that the drive pawl 5 is pot-shaped in cross-section with the central axis of rotation 6 and the peripheral toothed segment 5a as well as the extension arm 5b. For this purpose, the design in detail is such that the drive pawl 5 rests on a truncated cylinder 7, which can be seen for the most part in FIG. 2, or is coupled in a rotationally fixed manner to this truncated cylinder 7 with a common definition of the axis of rotation 6. The truncated cylinder 7 has a contour 8 on its outer circumference, which is designed to interact with a sensor 9.

According to the embodiment, the sensor 9 is a switch and in particular a microswitch. In this way, the angular position of the drive pawl 5 can be queried using the sensor or microswitch 9. This makes it possible for the extension arm 5b, as a component of the drive pawl 5, to be arranged in a parking region P in the unloaded state, which is shown schematically in FIG. 3.

This parking region P in part of a possible angular position or an angular range which the extension arm 5b of the drive pawl 5 can cover, without the pawl 2 or the rotary latch 1 being acted upon in the basic state shown in FIG. 3. In this respect, the parking region P takes into account any variations in the assumption of the basic position by the extension arm 5b. Such variations can be attributed to fluctuating voltages acting on the opening/closing drive 4, temperature differences or to the fact that the basic position is approached from the opening direction O or the closing direction Z as shown in FIG. 3.

In any case, by taking up the parking region P on the part of the extension arm 5b of the drive pawl 5, it is possible to make any stops, stop buffers, etc. for the drive pawl 5 completely unnecessary. This reduces the design effort and manufacturing costs. Within the parking region P, the sensor 9 or microswitch therefore emits a consistently identical parking signal or sensor signal to a control unit (not expressly shown) for evaluating the drive movement of the opening/closing drive 4.

The mode of operation is as follows. Starting from the parking position or basic position of the drive pawl shown in FIG. 1, an action by the single and combined opening/closing drive 4 of the drive pawl 5 in the closing direction Z in a clockwise direction about the axis of rotation 6 ensures that the extension arm 5b of the drive pawl 5 moves against a pin connected to the rotary latch 1 and indicated. The clockwise movement of the extension arm 5b now causes the rotary latch 1 in the embodiment according to FIG. 1 to be pivoted counterclockwise about its axis. For this purpose, the rotary latch 1 in the illustration according to FIG. 1, for example, has assumed its pre-locking position and is transferred to the main locking position by means of the extension arm 5b of the drive pawl 5 through the described movement. In principle, the rotary latch 1 can also be pivoted into an overstroke position with the aid of the drive pawl 5 in order to subsequently facilitate the engagement of the pawl 2. The drive pawl 5 is then returned to its basic position or the parking region P. This corresponds to a movement of the drive pawl 5 in the counterclockwise direction.

Starting from the basic position or the parking region P, acting on the extension arm 5b in the opening direction Ö now causes the extension arm 5b to pivot counterclockwise. During this process, the extension arm 5b moves against a stop contour of the pawl 2 and ensures that the pawl 2 is pivoted clockwise about its axis in the embodiment. The clockwise movement of the pawl 2 in relation to the rotary latch 1 now causes the pawl 2 to leave its locking position in relation to the rotary latch 1. As a result, the rotary latch 1 can move (in a spring-assisted manner) into its open position and release a previously held locking bolt (not shown). The locking mechanism 1, 2 is therefore opened. The same applies to the associated motor vehicle door.

### LIST OF REFERENCE SIGNS

1,2 Locking mechanism
1 Rotary latch
2 Pawl
3 Lock housing
4 Closing drive or opening drive, gear wheel
5 Drive pawl
5a Toothing
5b Extension arm
6 Axis
7 Truncated cylinder
8 Contour
9 Sensor or switch, microswitch
Ö Opening direction
P Parking region
Z Closing direction

1. A motor vehicle lock comprising:
a locking mechanism including a rotary latch and a pawl,
a closing drive and an opening drive for the locking mechanism, and
a drive pawl for acting on the locking mechanism,
wherein the closing drive and the opening drive are configured as a single and combined opening/closing drive, which acts on the drive pawl in an opening direction for acting on the pawl and in an opposite closing direction for acting on the rotary latch.

2. The motor vehicle lock according to claim 1, wherein the drive pawl has a toothing for engagement with a gear wheel of the combined opening/closing drive.

3. The motor vehicle lock according to claim 1, wherein the drive pawl comprises a toothed segmented wheel which is rotatable about an axis.

4. The motor vehicle lock according to claim 3, wherein the drive pawl has an extension arm which acts on the pawl or the rotary latch.

5. The motor vehicle lock according to claim 4, wherein a toothed segment of the drive pawl and the extension arm are arranged at an angular distance from one another.

6. The motor vehicle lock according to claim 4, wherein the drive pawl further comprises a pot-shaped cross section with a central axis of rotation.

7. The motor vehicle lock according to claim 4, further comprising a sensor, wherein the drive pawl has a contour for interaction with the sensor which queries an angular position of the drive pawl.

8. The motor vehicle lock according to claim 7, wherein the extension arm of the drive pawl is arranged in an unloaded state in a parking region which acts neither on the pawl nor on the rotary latch.

9. The motor vehicle lock according to claim 8, wherein the sensor detects the parking region.

10. The motor vehicle lock according to claim 1, wherein the drive pawl is a metal and/or plastics molded part.

11. The motor vehicle lock according to claim 2, wherein the toothing is positioned on only one peripheral segment of the drive pawl that engages with the combined opening/closing drive.

12. The motor vehicle lock according to claim 7, wherein the contour is positioned on a truncated cylinder that is connected to the drive pawl.

13. The motor vehicle lock according to claim 12, wherein the truncated cylinder defines a central axis of the drive pawl.

14. The motor vehicle lock according to claim 1, wherein the combined opening/closing drive acting in the opening direction comprises pivoting the drive pawl about an axis of rotation in a first direction, and the combined opening/closing drive acting in the closing direction comprises pivoting the drive pawl about the axis of rotation in a second direction opposite from the first direction.
